(19) United States
(12) Patent Application Publication
(10) Pub. No.: US 2009/0288104 A1
(43) Pub. Date: Nov. 19, 2009

(54) EXTENSIBILITY FRAMEWORK OF A NETWORK ELEMENT

(75) Inventors: Nagaraj Bagepalli, San Jose, CA (US); David Chang, Milpitas, CA (US); Surendra Kumar, San Ramon, CA (US); Abhijit Patra, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Rohati Systems, Inc., Sunnyvale, CA (US)

(21) Appl. No.: 12/123,225

(22) Filed: May 19, 2008

(51) Int. Cl. G06F 9/54; G06F 15/173

(52) U.S. Cl. 719/328; 709/232

(57) ABSTRACT

Techniques for providing extensibility framework for processing network packets are described herein. In one embodiment, in response to a packet received at a network element, the packet is processed using a generic process for performing a first type of operations required by the packet, wherein the first type of operations is common to a type of the packet. An extended process is invoked, via an extensibility application programming interface (API), to perform a custom operation that is not common to the generic process and is not statically known to the generic process, in order to determine whether the packet is eligible to access a resource of at least one of a plurality of application servers of a datacenter, including a layer-7 access control process. The network element operates as an application service gateway for the datacenter. Other methods and apparatuses are also described.

### FIELD OF THE INVENTION

The present invention relates generally to network packet processing. More particularly, this invention relates to an extensibility framework for customizing packet processing.

### BACKGROUND

Proxies have been utilized in many network elements or routers for handling a variety of functionalities for processing network packets. A proxy is an intermediary device that sits in the middle of a client to server connection. It terminates the incoming connection, performs byte-stream level processing and re-initiates another connection towards the server. In effect, the proxy device breaks the original client server connection into two halves, one between client and proxy (client-connection) and another between proxy and the server (server-connection).

Also, proxy device need to take care of the disparate network conditions between client and server connections (server connection might be much faster than the client connection). For example, a proxy device might implement some kind of flow control mechanism between client and server connections.

A proxy is said to be transparent when it reuses client's original IP address and source port number while re-initiating the connection towards server, whereas if it allocates a new IP address and source port number for the server connection it's known as non-transparent proxy. The process of translating the original client IP and port number to a new client IP and port number is known as client NAT (network address translation). A proxy may choose to translate the original server IP and port number as well, and this process is known as Server NAT.

Typically, proxies are developed using various scripting languages and are executed within a network element for handling certain functionalities. However, there has been a lack of flexible framework for a developer to develop certain customized functionalities that are not common to ordinary proxies.

### SUMMARY OF THE DESCRIPTION

Techniques for providing extensibility framework for processing network packets are described herein. In one embodiment, in response to a packet received at a network element, the packet is processed using a native proxy for performing a first type of operations required by the packet, wherein the first type of operations is common to a type of the packet. An extended proxy is invoked, via an extensibility application programming interface (API), to perform a custom operation that is not common to the native proxy and is not statically known to the native proxy, in order to determine whether the packet is eligible to access a resource of at least one of a plurality of application servers of a datacenter, including a layer-7 access control process. The network element operates as an application service gateway for the datacenter and in order to access a resource of the datacenter, each client has to go through the network element and authenticated and/or authorized by the network element.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating an example of a network configuration according to one embodiment of the invention.

FIGS. 2A and 2B are block diagrams illustrating an example of an application service appliance or gateway according to certain embodiments.

FIG. 3 is a block diagram illustrating an example of the extensibility framework according to one embodiment.

FIG. 4 is a block diagram illustrating an example of usage of the extensibility framework according to one embodiment.

FIG. 5 is a flow diagram illustrating a process for customizing packet processing using an extensibility framework according to one embodiment.

FIGS. 6A-6B are pseudo codes representing an example of particular usage of the extensibility framework according to one embodiment.

FIGS. 7A-7B are pseudo codes representing another example of particular usage of the extensibility framework according to another embodiment.

FIG. 8 is pseudo code representing another example of particular usage of the extensibility framework according to another embodiment.

FIGS. 9A-9H illustrate a list of specific extensibility APIs according to certain embodiments.

### DETAILED DESCRIPTION

Techniques for providing extensibility framework for processing network packets are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments of the invention, an extensibility framework having a set of APIs (application programming interfaces) are used as a set of building blocks that is part of simple scripting programming language (e.g., Lua programming language). These APIs may be utilized in user written scripts to extend the functionality of certain components of an application service appliance or application service gateway, to address certain custom needs that are not normally available from the native functionality. For example, according to one embodiment, dynamic attributes, in a form of custom scripts, can be used to extend the policy framework which further enables custom policy enforcement. In addition, native proxy functionality, such as HTTP (hypertext transport protocol), can be enhanced with the help of custom script to address specific needs. Furthermore, logic to parse proprietary protocols over a reliable transport protocol such as TCP (transport control protocol) can easily be written using the extensibility framework APIs.

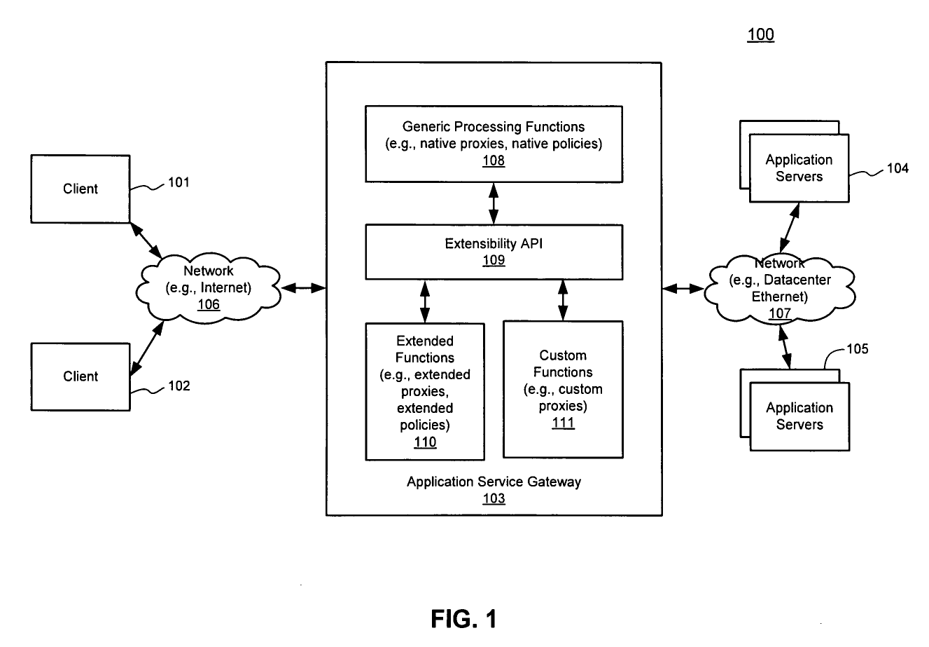

FIG. 1 is a block diagram illustrating an example of a network configuration according to one embodiment of the invention. Referring to FIG. 1, network configuration 100 includes one or more clients 101-102 communicatively coupled to an application service gateway or appliance device 103 in order to access one or more application servers 104-105 of a datacenter over networks 106-107. In order to access applications hosted by application servers 104-105, each of the clients 101-102 has to go through application service appliance 103 over networks 106-107. Network 106 may be a local area network (LAN) or a wide area network (WAN). Alternatively, network 106 may be an internal network of an entity such as intranet. Network 107 may be a converged fabric network such as a datacenter Ethernet (DCE) or InfiniBand™ network.

According to one embodiment, device 103 is configured to perform attribute based authentication and/or authorization of clients 101-102 to determine whether a particular client is eligible to access application servers 104-105. In one embodiment, device 103 includes multiple processors or core logic (not shown) which can be used to process network packets in various ways based on one or more policies. Processors/core logic may be configured to process any of layer 2 to layer 7 of OSI (open system interconnect) network layers of processes. For example, one processor/core may be configured to process layer 2 to layer 5 while another processor/core may be configure to process layer 5 to layer 7, etc. In one embodiment processors/core logic may be implemented using an Octeon™ compatible processor available from Cavium Networks of Mountain View, Calif.

In one embodiment, application service appliance 103 includes certain software components that are running within one or more of the multiple processors/core logic, including generic processing functions 108 communicatively coupled to extended functions 110 and/or custom functions 111 via the extensibility APIs 109. The software components may be developed using a variety of programming languages and/or development tools. Generic functions 108 may include certain proxies such as protocol proxies. Extended functions may include any customized functionality that is not normally available or common to the generic functions 108. For example, an HTTP proxy may be able to process ordinary HTTP packets. However, the HTTP proxy may not be able to process certain proprietary protocols (e.g., parsing certain payload of a TCP/IP packet. A proxy may be written in a variety of scripting languages such as XACML (extensible access control markup language). In one embodiment, extended functions 110 may be written using a simple programming language such as Lua programming language. Custom functions 111 may include those custom proxies (e.g., proprietary protocol proxy).

Note that network configuration 100 is shown for illustration purposes only. For example, networks 106-107 may be the same network or different networks. Other configurations may exist.

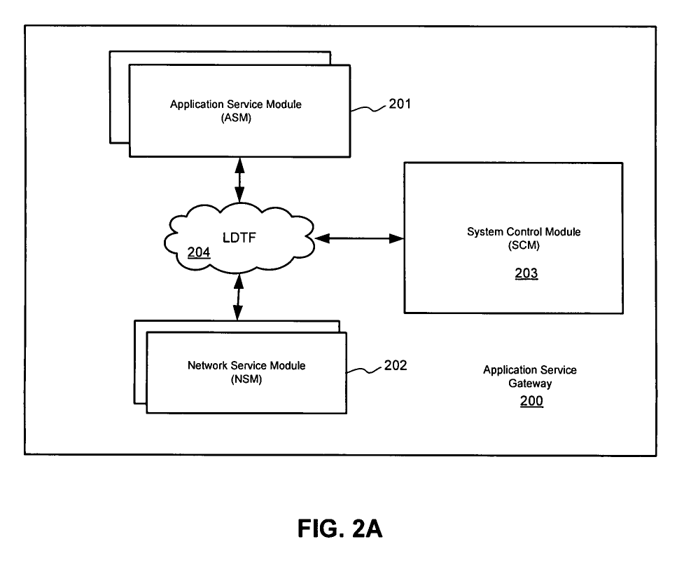

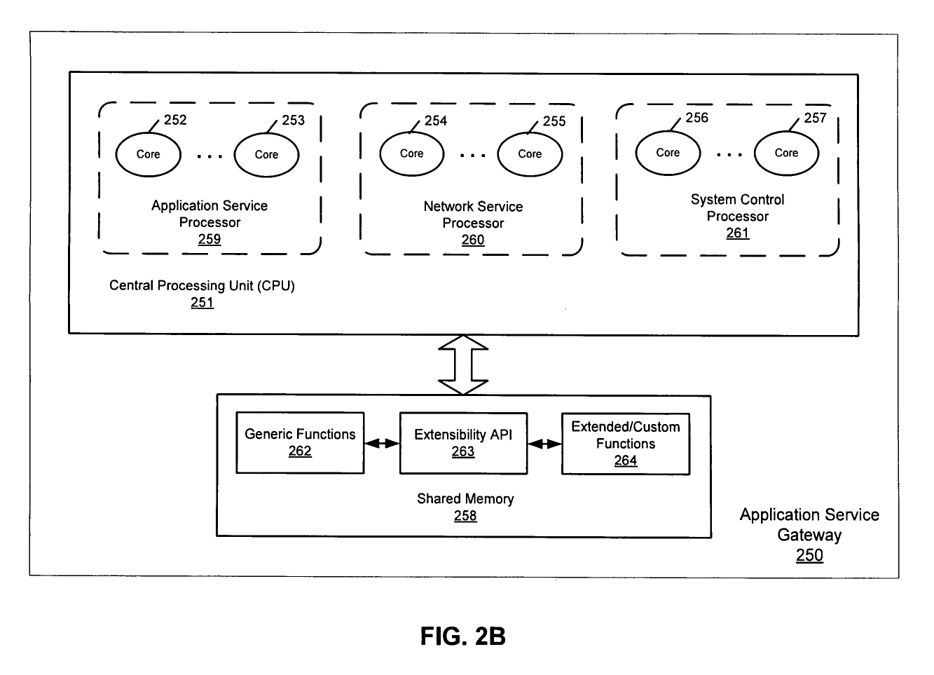

FIG. 2A is a block diagram illustrating an example of an application service appliance or gateway according to one embodiment. For example, device 200 may be implemented as part of application service appliance 103 of FIG. 1. Referring to FIG. 2A, application service appliance 200 includes, but is not limited to, one or more application service modules (ASMs) 201 (also referred to as an application service plane) communicatively coupled to one or more network service modules (NSMs) 202 (also referred to as a network service plane) over a lossless switch fabric 204 (also referred to as a lossless data transport fabric or LDTF), which may be an InfiniBand™ compatible switch fabric. In addition, application service appliance 200 includes a system control module (SCM) 203 (also referred to as a management plane) coupled to the LDTF 204 for managing the ASMs 201 and NSMs 202.

ASMs 201 are configured to perform layer 4 to layer 7 access control based on attribute-based policies, including performing triangulated authorization based on various attributes, including user attributes, network attributes, environment attributes, and/or resource attributes, etc. An NSM includes one or more network service processor (NSP) and an ASM includes one or more application service processors (ASP).

According to one embodiment, application service appliance 200 is essentially a high-speed full-proxy device and it needs to terminate both client and server ends of a client to server connection. In effect application service appliance 200 acts as a virtual server to actual clients (e.g., clients 101-102 of FIG. 1), and a virtual client to actual servers (e.g., servers 104-105 of FIG. 1). Also, application service appliance 200 is configured to scale in order to be able to process a significant portion of the traffic passing through. This highly-scalable L7 processing bandwidth is a unique differentiator for application service appliance 200, as opposed to existing L4-L7 devices, as they expect the bulk of the traffic processing through the device to be unexamined and unchanged, hence can use a high-speed flow-switching fast path to achieve the target throughput.

According to one embodiment, SCM 203 is responsible for common system management functions as well as configuration and management of processing elements in network and application plane. The SCM 203 includes a low-end processor (also referred to as a management service processor) and has an additional out-of-band connectivity to processing elements on ASMs 201 and NSMs 202. Typically, image download, configuration information, statistic collection messages are exchanged between SCM 203 and rest of the system.

In one embodiment, NSM 202 is responsible for ingress and egress processing of external data path, IP stack for virtual interface, TCP and SSL termination, fast path flow switching, byte stream load balancing among multiple ASMs, and stream replication to a backup NSM, etc. ASM 201 is responsible for protocol proxy such as HTTP, CIFS, JDBC, etc. ASM 201 may include a protocol recognition engine, regular expression engine, rule engine, and application authorization engine, etc.

The software architecture of application service appliance 200 employs the combination of both these approaches for providing a layer 7 service. For example, TCP/SSL function is performed on one set of cores and then application processing is performed on another set of cores. Cores running application are equally capable and any available core can be used for application processing.

In one embodiment, the extensibility framework APIs are provided within ASMs 201 to allow a generic function or proxy to invoke an extended function or extended proxy for customized operations (e.g., uncommon or unknown features or functionality).

Note that ASMs 201 and NSMs 202 may be implemented as part of multiple processors, where each processor may include multiple cores or alternatively, ASMs 201 and NSMs 202 may be implemented as part of a single processor having multiple cores communicatively coupled to each other via an interconnect or bus, or a shared memory.

FIG. 2B is a block diagram illustrating an example of an application service appliance or gateway according to an alternative embodiment. Referring to FIG. 2B, here in this example, application service gateway or appliance 250 is implemented using a single processor 251 having multiple cores 252-257 (e.g., 16 cores). Certain portions of cores 252-257 may be logically configured or partitioned to be designated as an application service processor (ASP) as part of an ASM, a network service processor (NSP) as part of an NSM, or a system control processor (SCP) as part of an SCM described above.

In this example, as shown in FIG. 2B, cores 252-253 are logically configured as an ASP 259; cores 254-255 are logically configured as an NSP 260; and cores 256-257 are logically configured as an SCP 261. The functionalities of ASP 259, NSP 260, and SCP 261 are similar to those as shown in FIG. 2A. For example, ASP 259 may be configured to handle layer 5 to layer 7 processes while NSP 260 may be configured to handle layer 2 to layer 5 processes. Note that although a single ASP, NSP and SCP are shown; multiple ASPs, NSPs, and SCPs may also be implemented, dependent upon a specification design.

In one embodiment, ASP 259, NSP 260, and SCP 261 communicate with each other via a bus or an interconnect, as well as via shared memory 258. Shared memory 258 may be implemented as an internal memory of CPU 251, an external memory, or a combination of both internal and external memories with respect to CPU 251. Further generic functions 262 communicatively coupled to extended functions 264 via extensibility API 263 is loaded and running within shared memory 258 and having functionality similar to components 108-111 of FIG. 1.

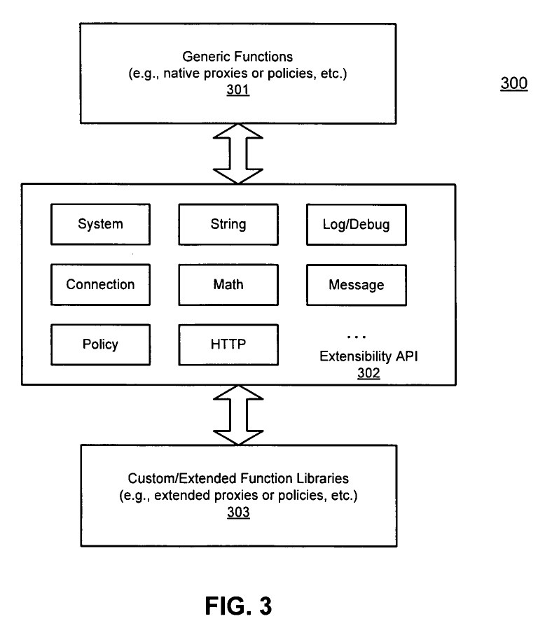

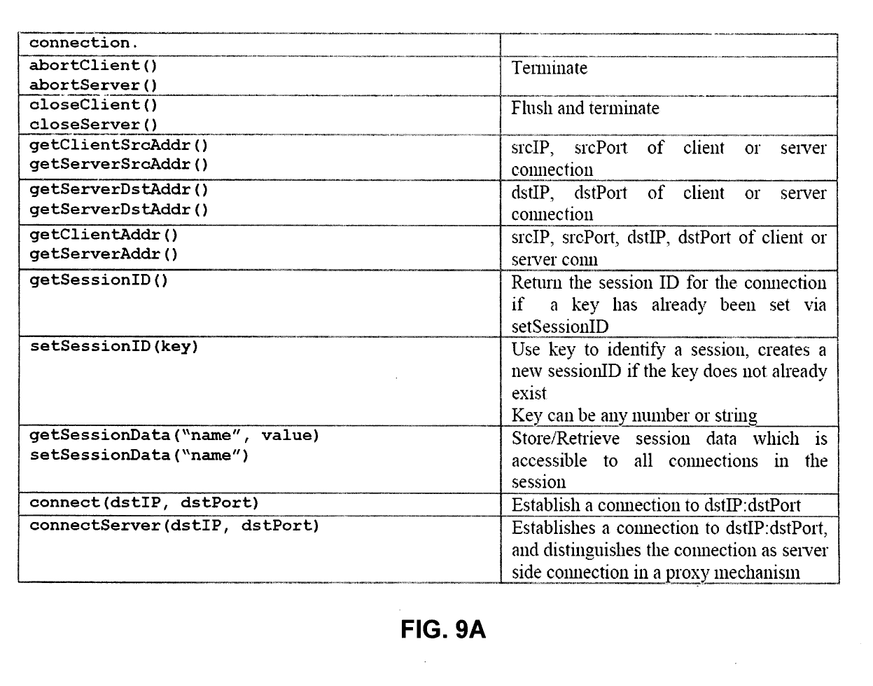

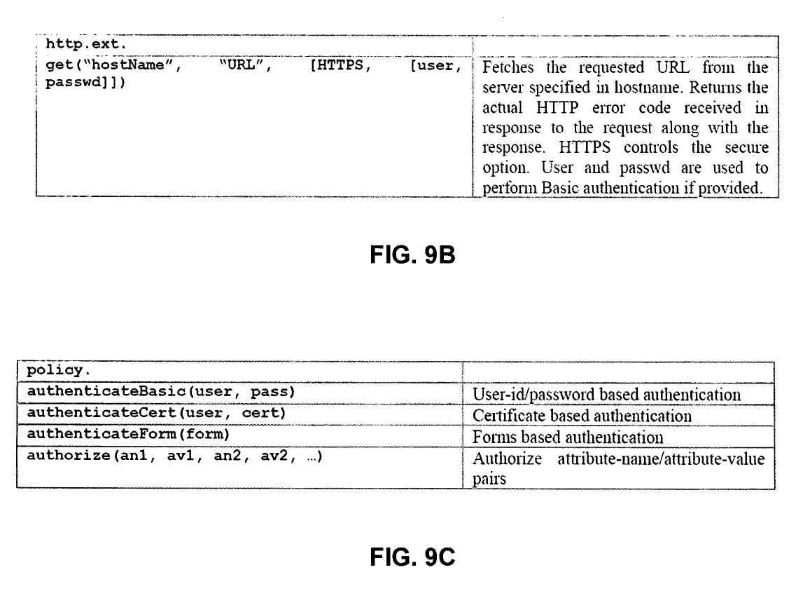

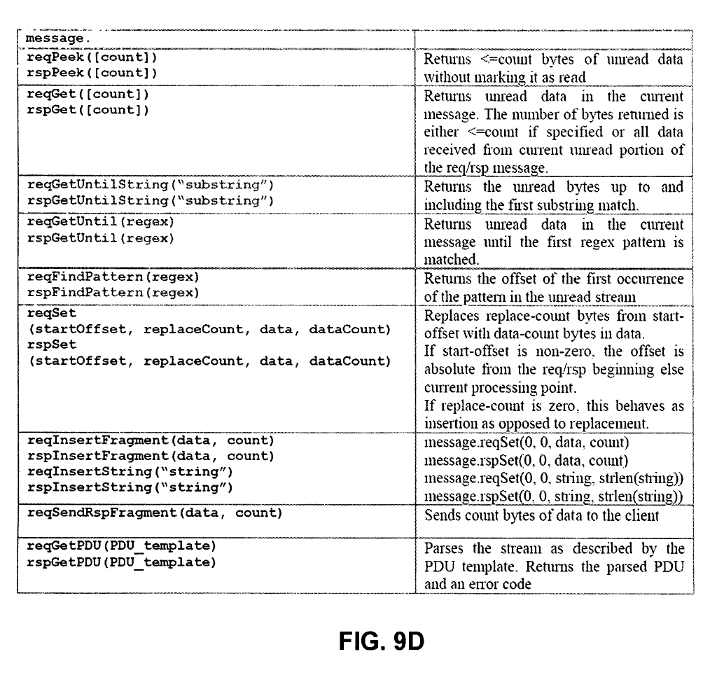

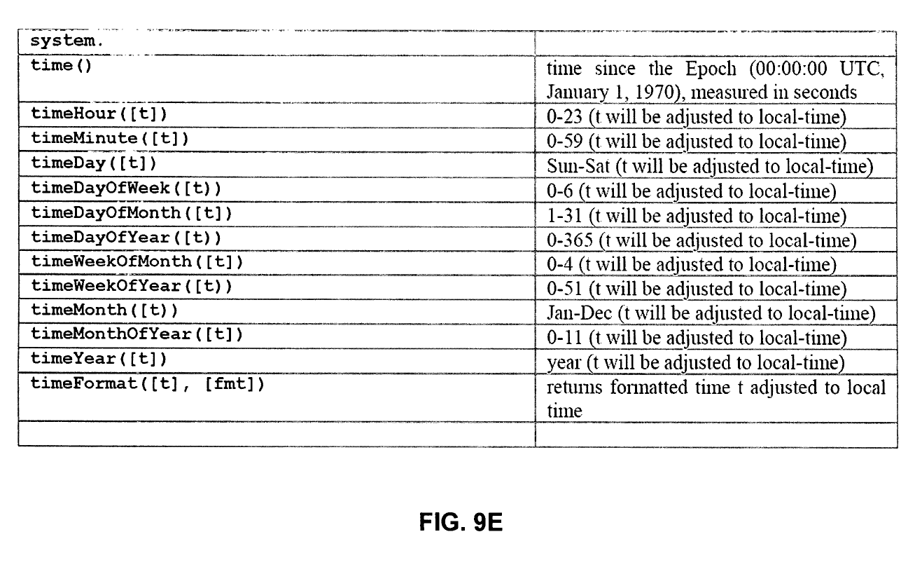

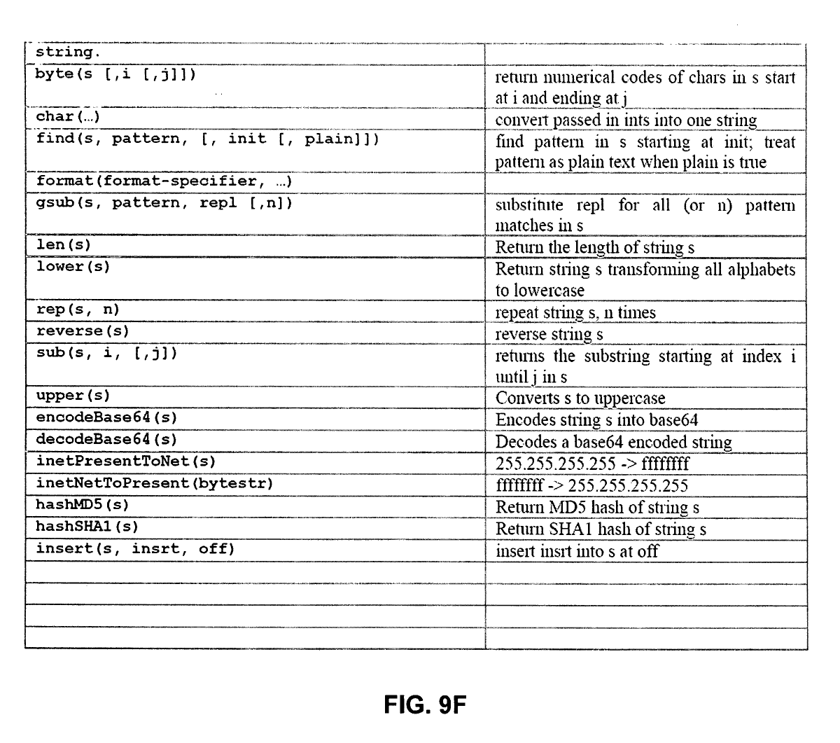

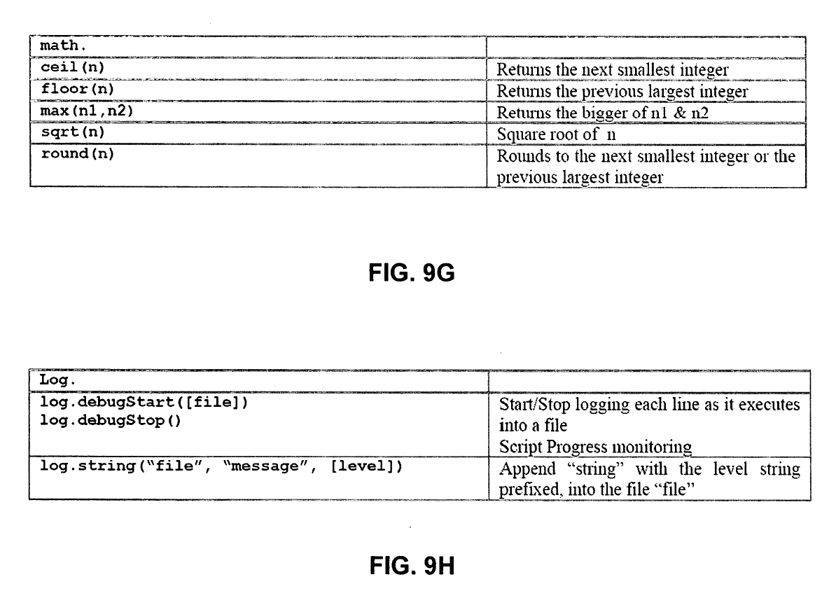

FIG. 3 is a block diagram illustrating an example of the extensibility framework according to one embodiment. Referring to FIG. 3, framework 300 includes one or more functions configured to invoke one or more custom or extended functions 303 via a set of extended APIs 302. For example, components 301-303 may be implemented as part of components 108-110 of FIG. 1 or components 262-264 of FIG. 2B respectively. In one embodiment, the extensibility API 302 includes multiple sets of APIs for a variety of categories, such as, for example, system APIs, string handling APIs, log/debug APIs, connection APIs, math or computing APIs, message related APIs, policy related APIs, and/or protocol (e.g., HTTP) related APIs, etc. Some of these APIs are listed in FIGS. 9A-9H as examples for the purposes of illustration.

According to certain embodiments, the custom and/or extended functions 303 may be accessed or invoked from the generic functions 301 via the APIs 302. As a result, a set of common functionalities may be provided in generic functions 301 as a template or a base class while the extended functions 303 may be utilized as a specific functions developed by a specific developer. Note that generic functions 301 and extended functions 303 may be developed by different developers of different organizations, as long they are compliant with the extensibility APIs 302. As a result, for example, when a proprietary protocol needs to be handled by the application service appliance, the vendor associated with the proprietary protocol may provide an extended protocol proxy as part of extended function 303 that is compliant with the extensibility APIs 302. The corresponding protocol proxy may then be configured to invoke the extended protocol proxy to handle the proprietary protocol without having to know exactly how the proprietary protocol is to be handled.

According to one embodiment, for a native proxy such as a native protocol proxy, the extensibility framework provides an extension such as a protocol extension, for example, for rewrite of the response payload. In addition, as a policy extension, the extensibility framework provides additional functionality such as processing dynamic attributes via remote calls. Further, for a custom protocol (e.g., proprietary protocol), the extensibility framework provide a mechanism in a form of a custom proxy to handle the specific operations of the custom protocol. For example, the extensibility framework may instantiate a generic TCP/IP proxy and write a script to personalize that proxy to any client-server TCP/IP protocols.

The extended functions 303 may be developed using a variety of simple scripting languages. In one embodiment, the extended functions 303 are developed using Lua programming language. Lua programming language is a lightweight, reflective, imperative and procedural language, designed as a scripting language with extensible semantics as a primary goal.

Lua is commonly described as a “multi-paradigm” language, providing a small set of general features that can be extended to fit different problem types, rather than providing a more complex and rigid specification to match a single paradigm. Lua, for instance, does not contain explicit support for inheritance, but allows it to be implemented relatively easily with metatables. Similarly, Lua allows programmers to implement namespaces, classes, and other related features using its single table implementation; first class functions allow the employment of many powerful techniques from functional programming; and full lexical scoping allows fine-grained information hiding to enforce the principle of least privilege.

In general, Lua strives to provide flexible meta-features that can be extended as needed, rather than supply a feature-set specific to one programming paradigm. As a result, the base language is light—in fact, the full reference interpreter is only about 150 kB compiled—and easily adaptable to a broad range of applications. Lua is a dynamically typed language intended for use as an extension or scripting language, and is compact enough to fit on a variety of host platforms. It supports only a small number of atomic data structures such as Boolean values, numbers (double-precision floating point by default), and strings. Typical data structures such as arrays, sets, hash tables, lists, and records can be represented using Lua's single native data structure, the table, which is essentially a heterogeneous map.

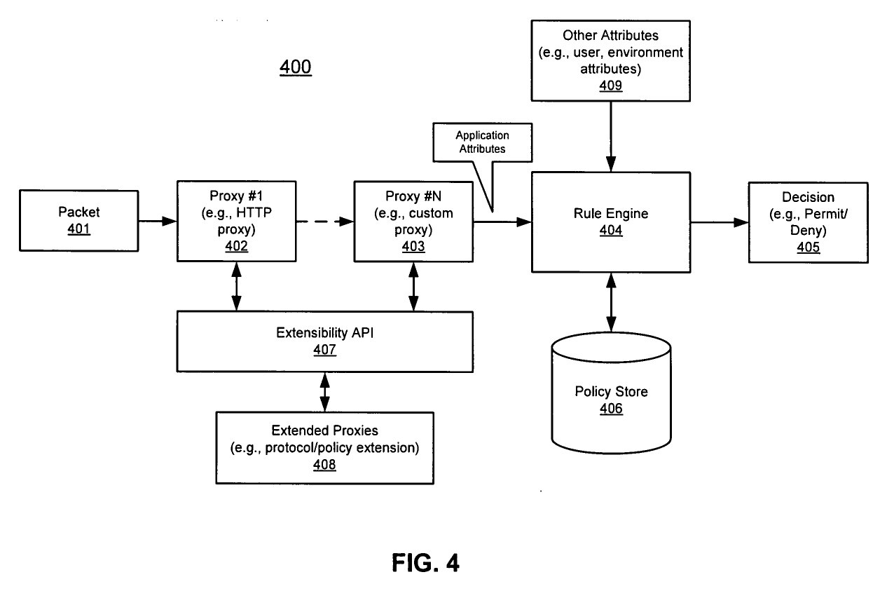

FIG. 4 is a block diagram illustrating an example of usage of the extensibility framework according to one embodiment. For example, system 400 may be implemented as part of system of FIG. 2A or FIG. 2B. Referring to FIG. 4, when a packet 401 is received, in order to determine whether the packet 401 is eligible to access a resource (e.g., application) of a datacenter, the packet 401 has to be examined, for example, by one or more proxies such as proxies 402-403, etc. Note that for the purposes of illustration, only two proxies are shown; however, more or fewer proxies may be implemented. Also note that proxies 402-403 are shown in series for the purposes of illustrating only; however, proxies 402-403 may be executed by multiple processors and/or core logic in a variety of execution modes, such as, for example, pipelined mode, parallel mode, or a combination of both. For example, packets of different flows and packets of the same flow but in different processing stages may be processed by multiple proxies executed by multiple cores concurrently.

In this example, referring back to FIG. 4, packet 401 may be a packet with a particular protocol and is processed by proxy 402 as a protocol proxy (e.g., TCP or HTTP proxy). In order to understand the protocol semantics and perform the actions specified in the policy, a protocol proxy needs to be implemented. Building a proxy for a standard protocol like HTTP is a well known task. However, there might be some customer specific custom protocol written on top of TCP; mechanisms need to be provided for understanding the semantics of these custom protocols. Depending on the application, a proxy might need to just parse the request, response or both. For example, network based authorization application just need to parse the request to determine whether the given transaction need to be allowed or not. In general protocol proxy need to perform the following functions:

Understand the request/response message boundaries

Parse the protocol message contents to derive the required headers

Perform configured protocol specific actions

Referring back to FIG. 4, it is assumed that packet 401 is an HTTP packet. When system 400 receives packet 401, a service lookup operation is performed to determine which protocol proxy should be used to process the packet. In one embodiment, an incoming packet inspector may examine the destination IP address of the packet 401 as well as the TCP port to determine which protocol proxy should be used. For example, a packet having a port number 80 normally indicates that the packet is an HTTP packet.

In this example, protocol proxy 402 is used as a generic HTTP proxy to handle standard HTTP processing. However, when it comes to parsing or rewriting the payload of packet 401, protocol proxy 402 may invoke an extended protocol proxy as part of extended proxies 408 that is designed to handle the payload of HTTP packets via the extensibility API 407. The extended proxy may be used to rewrite the payload of HTTP response packets based on information extracted from corresponding HTTP request packets. For example, if an HTTP request packet comes form a security auditor, the HTTP request packet may include certain personal sensitive information. Such information may need to be masked out or modified (e.g., masking out entire or at least a portion of a social security number, etc.), which operations may be implemented via a protocol extension or an extended protocol proxy.

According to another scenario, packet 401 may include certain dynamic attributes (e.g., username or account balance) embedded within the payload of the packet 401. As a result, after the generic proxy 402 has processed the protocol and/or standard attributes, an extended function (e.g., policy extension) as part of extended proxies 408 may be invoked via APIs 407 to extract the specific dynamic attributes which may be submitted to rule engine 404, as part of application attributes as well as other attributes 409 such as user and environment attributes, etc., in view of one or more policies stored in the policy store 406, in order to determine whether the request by the packet is permitted or denied 405.

Furthermore, extensible script 408 may be implemented as a custom logic (e.g., a custom proxy) to handle a proprietary protocol. The attributes extracted from such a protocol are fed to rule engine 404 to authenticate the user as well as to authorize the resource. If the policy does not authenticate the user, the script can send an error message and close the client connection. The custom script further has the ability to inspect or modify some or all data in a flow in either direction (e.g., client to server, or vice versa).

Rule engine 404 is the heart of the system 400 for evaluating the policy rules configured in the system and arriving at the decisions to be performed for a given transaction. XACML is used for configuring the rules. After the rules are evaluated, rule engine could come up with a set of actions to be performed in addition to permit or deny, including copying the transaction to a configured recording device; encrypting the backend session towards the server; inserting custom http headers for http transactions; and setting the marking of IP TOS field to give correct priority to the transaction, etc.

XACML is an OASIS (Organization for the Advancement of Structured Information Standards) standard that describes both a policy language and an access control decision request/response language (both encoded in XML). The policy language is used to describe general access control requirements, and has standard extension points for defining new functions, data types, combining logic, etc. The request/response language allows one to form a query to ask whether or not a given action should be allowed, and interpret the result. The response always includes an answer about whether the request should be allowed using one of four values: permit, deny, indeterminate (an error occurred or some required value was missing, so a decision cannot be made) or not applicable (the request can't be answered by this service). The request/response language helps to define a standard distributed architecture where in multiple disparate external PEPs (policy enforcement points) communicate with a centralized PDP (policy decision point) for determining an access control decision.

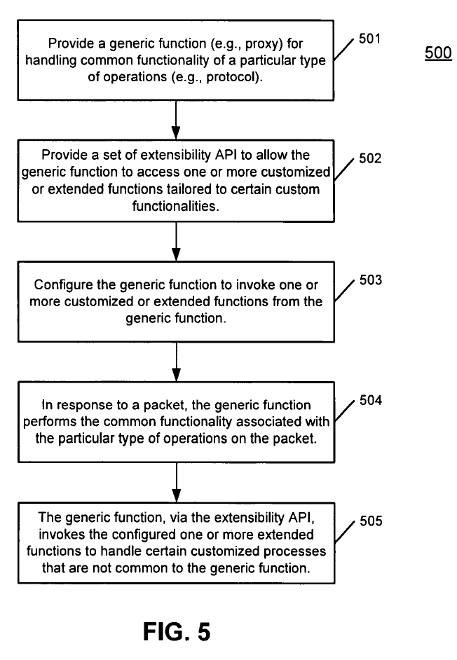

FIG. 5 is a flow diagram illustrating a process for customizing packet processing using an extensibility framework according to one embodiment. Note that process 500 may be performed by processing logic which may include software, hardware, or a combination of both. For example, process 500 may be performed by system 400 of FIG. 4. Referring to FIG. 5, at block 501, a generic function (e.g., generic proxy) is provided for handling any common functionality of a particular type of operations (e.g., protocols). At block 502, a set of extensibility APIs is provided to allow the generic function to access or invoke one or more customized or extended functions tailored to certain custom functionalities. At block 503, the generic function is configured to invoke one or more customized or extended functions from the generic function (e.g., providing a hook from the generic function to a customized function at configuration time using the extensibility APIs). At block 504, in response to a packet requesting an access to a resource of a datacenter, the generic function performs the common functionality associated with the particular type of operations on the packet. At block 505, the generic function, via the extensibility APIs, invokes the configured one or more extended functions to handle certain customized processes that are not common or unknown to the generic function. Other operations may also be performed.

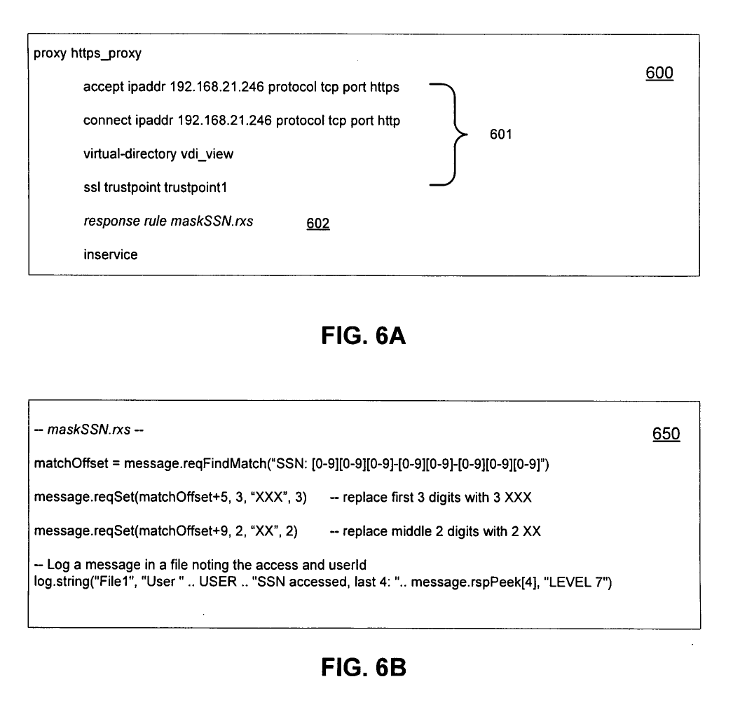

FIGS. 6A-6B are pseudo codes representing an example of particular usage of the extensibility framework according to one embodiment. In this example, FIG. 6A shows a generic HTTPS proxy 600 that performs certain HTTPS related operations 601. In addition, HTTP proxy 600 invokes a customized function 650 of FIG. 6B via the extensibility API call 602. This example extension adds additional logic to the HTTPS proxy 600 to mask a social security number (SSN) in the HTTP response data before sending it across the client. In this example, the SSN occurrences are assumed to be of the form “SSN: ddd-dd-ddd”, where the “d” stands for a decimal digit (0-9). The modified data will only reveal the last four digits of the SSN.

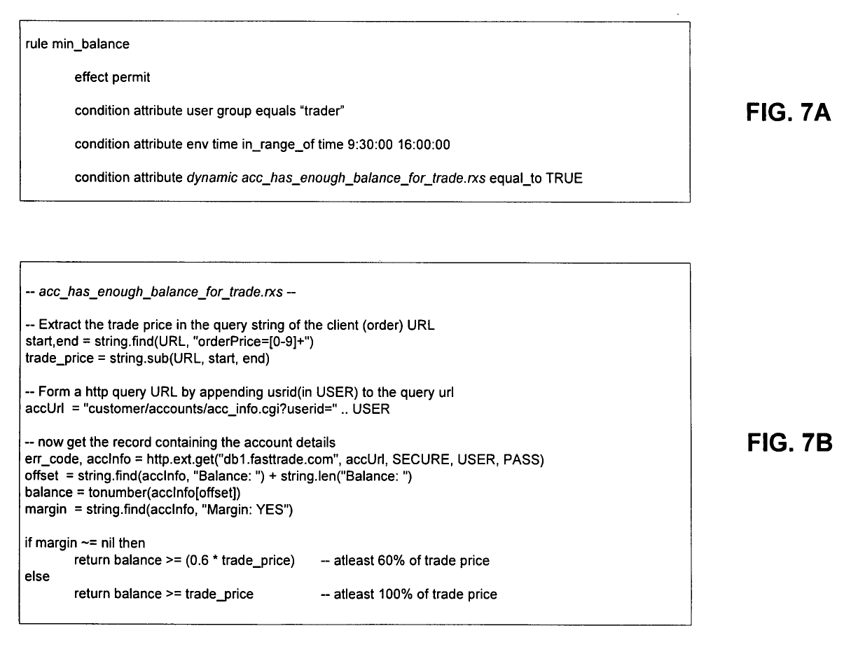

FIGS. 7A-7B are pseudo codes representing another example of particular usage of the extensibility framework according to another embodiment. This example extension adds additional logic as shown in FIG. 7B to fetch the customer's account balance from a banking database at a trading firm before being allowed to place a trade, thereby enforcing a minimum balance rule as shown in FIG. 7A. In this example, the script obtains the account information of a particular user through the HTTPS interface of the banking database. The script can as well write SQL (structured query language) query and send it across the Web interface. The script processes the response to extract the balance amount and convert the balance amount into a number before returning the response. The script itself acts as a dynamic attribute. The value returned by the script is thus used as a dynamic attribute value and the policy evaluation is performed as with a static attribute.

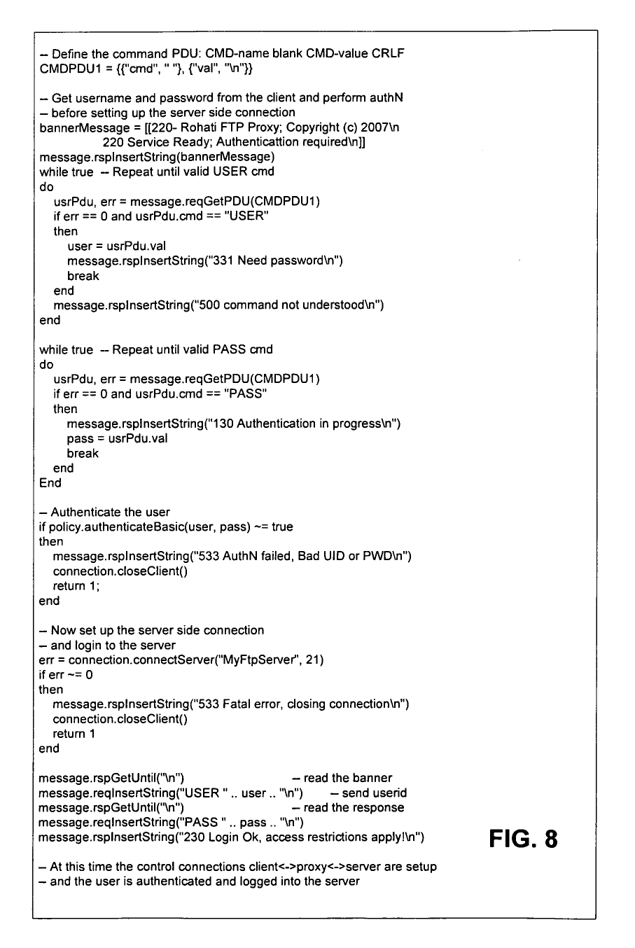

FIG. 8 is pseudo code representing another example of particular usage of the extensibility framework according to another embodiment. Referring to FIG. 8, this example implements an FTP (file transport protocol) proxy using the extensibility API. As shown in FIG. 8, the script demonstrates parsing of the FTP comments via PDU temples and using various APIs (as shown in FIGS. 9A-9H) to process request and/or response, as well as authentication of the user. Configuration of this proxy is similar to the HTTP proxy except that a generic proxy is configured and the script associated with the generic proxy.

Thus, techniques for providing extensibility framework for processing network packets have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method performed by a network element, the method comprising:
in response to a packet received at the network element, processing the packet using a generic process for performing a first type of operations required by the packet, the first type of operations being common to a type of the packet; and
invoking, via an extensibility application programming interface (API), an extended process to perform a custom operation that is not common to the generic process and is not statically known to the generic process, in order to determine whether the packet is eligible to access a resource of at least one of a plurality of application servers of a datacenter, including a layer-7 access control process, wherein the network element operates as an application service gateway for the datacenter, and wherein in order to access a resource of the datacenter, each client has to go through the network element and authenticated and/or authorized by the network element.

2. The method of claim 1, further comprising:
performing a service lookup operation to determine types of operations to be performed on the packet; and
selecting the generic process from a plurality of generic processes statically configured to perform well-known operations associated with types of the plurality of generic processes respectively.

3. The method of claim 1, wherein the generic process is a native proxy configured to handle well-known operations of a protocol while the extended process is an extended proxy configured to handle extended operations that are not common to the well-known operations, including rewriting a payload of a response associated with the packet.

4. The method of claim 3, wherein rewriting the payload comprises rewriting a payload of HTTP response packets based on information extracted from corresponding HTTP request packets.

5. The method of claim 1, wherein the generic process is part of a TCP proxy configured to initiate a standard TCP/IP protocol and wherein the extended proxy is part of a custom proxy configured to personalize the standard TCP/IP protocol.

6. The method of claim 1, wherein the generic process is part of a policy proxy and wherein the extended process is configured to provide extended policy related services, including communicating with a remote facility for handling dynamic attributes that are used as part of application attributes used by the layer-7 access control process.

7. The method of claim 1, wherein the extended proxy is written using Lua programming language.

8. A machine-readable storage medium having instructions stored therein, which when executed by a processing logic, cause the processing logic to perform a method, the method comprising:
in response to a packet received at the network element, processing the packet using a generic process for performing a first type of operations required by the packet, the first type of operations being common to a type of the packet; and
invoking, via an extensibility application programming interface (API), an extended process to perform a custom operation that is not common to the generic process and is not statically known to the generic process, in order to determine whether the packet is eligible to access a resource of at least one of a plurality of application servers of a datacenter, including a layer-7 access control process, wherein the network element operates as an application service gateway for the datacenter, and wherein in order to access a resource of the datacenter, each client has to go through the network element and authenticated and/or authorized by the network element.

9. The machine-readable storage medium of claim 8, wherein the method further comprises:
performing a service lookup operation to determine types of operations to be performed on the packet; and
selecting the generic process from a plurality of generic processes statically configured to perform well-known operations associated with types of the plurality of generic processes respectively.

10. The machine-readable storage medium of claim 8, wherein the generic process is a native proxy configured to handle well-known operations of a protocol while the extended process is an extended proxy configured to handle extended operations that are not common to the well-known operations, including rewriting a payload of a response associated with the packet.

11. The machine-readable storage medium of claim 10, wherein rewriting the payload comprises rewriting a payload of HTTP response packets based on information extracted from corresponding HTTP request packets.

12. The machine-readable storage medium of claim 8, wherein the generic process is part of a TCP proxy configured to initiate a standard TCP/IP protocol and wherein the extended proxy is part of a custom proxy configured to personalize the standard TCP/IP protocol.

13. The machine-readable storage medium of claim 8, wherein the generic process is part of a policy proxy and wherein the extended process is configured to provide extended policy related services, including communicating with a remote facility for handling dynamic attributes that are used as part of application attributes used by the layer-7 access control process.

14. The machine-readable storage medium of claim 8, wherein the extended proxy is written using Lua programming language.

15. A network element, comprising:
a generic processing unit, in response to a packet received at the network element, for performing a first type of operations required by the packet, the first type of operations being common to a type of the packet;
a set of extensibility application programming interfaces (APIs); and
an extended processing unit capable of being invoked from generic processing unit via the extensibility APIs to perform a custom operation that is not common to the generic processing unit and is not statically known to the generic processing unit, in order to determine whether the packet is eligible to access a resource of at least one of a plurality of application servers of a datacenter, including a layer-7 access control process, wherein the network element operates as an application service gateway for the datacenter, and wherein in order to access a resource of the datacenter, each client has to go through the network element and authenticated and/or authorized by the network element.

16. The network element of claim 15, further comprising a rule engine to determine whether the packet is eligible to access a resource of at least one of a plurality of application servers of a datacenter, including performing the layer-7 access control process.

17. The network element of claim 15, wherein the generic process is a native proxy configured to handle well-known operations of a protocol while the extended process is an extended proxy configured to handle extended operations that are not common to the well-known operations, including rewriting a payload of a response associated with the packet.

18. The network element of claim 17, wherein rewriting the payload comprises rewriting a payload of HTTP response packets based on information extracted from corresponding HTTP request packets.

19. The network element of claim 15, wherein the generic process is part of a TCP proxy configured to initiate a standard TCP/IP protocol and wherein the extended proxy is part of a custom proxy configured to personalize the standard TCP/IP protocol.

20. The network element of claim 15, wherein the generic process is part of a policy proxy and wherein the extended process is configured to provide extended policy related services, including communicating with a remote facility for handling dynamic attributes that are used as part of application attributes used by the layer-7 access control process.
